(19) United States
(12) Patent Application Publication
(10) Pub. No.: US 2023/0092080 A1
(43) Pub. Date: Mar. 23, 2023

(54) FLUID PUMP

(71) Applicant: ROLLS-ROYCE plc, London (GB)

(72) Inventors: Chloe J. PALMER, Derby (GB); Benjamin J. EASTMENT, Bristol (GB)

(73) Assignee: ROLLS-ROYCE plc, (omitted)

(21) Appl. No.: 17/822,467

(22) Filed: Aug. 26, 2022

(30) Foreign Application Priority Data
Sep. 14, 2021 (GB) 2113063.8

(51) Int. Cl. F02C 7/232; F02C 3/22; F04B 53/10; F04B 53/12; F04B 39/00

(52) U.S. Cl. CPC F02C 7/232; F02C 3/22; F04B 39/0016; F04B 53/12; F04B 53/1077; F05D 2220/323; F05D 2260/60; F05D 2300/432; F05D 2300/611

(57) ABSTRACT

A fluid pump is shown, comprising: a chamber comprising an inlet and an outlet, the outlet comprising a non-return valve, the chamber having a cavity comprising a cylinder; a piston slidably disposed within the cylinder; and a Tesla valve in fluid communication with the inlet, wherein the fluid pump is configured to pump fluid from the inlet to the outlet by reciprocation of the piston within the cylinder.

### CROSS-REFERENCE TO RELATED APPLICATIONS

This specification is based upon and claims the benefit of priority from United Kingdom Patent Application Number GB 2113063.8 filed on Sep. 14, 2021, the entire contents of which is incorporated herein by reference.

### BACKGROUND

### Technical Field

This present disclosure relates to a fluid pump and use thereof.

In order to limit emissions of carbon dioxide, use of hydrogen as an alternative to hydrocarbon fuel in gas turbine engines has historically only been practical in land-based installations. Such engines are typically supplied with hydrogen derived from natural gas via concurrent steam methane reformation, which hydrogen is injected into large-volume series staged dry low NOₓ burners. This type of burner is not suitable for use in an aero engine primarily due to its size and the difficulties in maintaining stable operation during transient manoeuvres.

### Description of The Related Prior Art

Experimental programmes have been conducted to develop aero engines operable to be fuelled with hydrogen, however these have typically been high-Mach afterburning turbojets or expander cycles and thus not practical for use on civil airliners operating in the Mach 0.8 to 0.85 regime.

There is therefore a need for technologies to facilitate combustion of hydrogen in aero gas turbine installations, in particular around the fuel system.

### SUMMARY

In a first aspect there is provided a fluid pump, comprising:
a chamber comprising an inlet and an outlet, the outlet comprising a non-return valve, the chamber having a cavity comprising a cylinder;
a piston, slidably disposed within the cylinder; and
a Tesla valve in fluid communication with the inlet,
wherein the fluid pump is configured to pump fluid from the inlet to the outlet by reciprocation of the piston within the cylinder.

In an embodiment, the non-return valve comprises a biasing mechanism to bias the non-return valve towards being closed. In an embodiment, the biasing mechanism comprises a spring. In an embodiment, the biasing mechanism is adjustable. In an embodiment, the biasing mechanism is pneumatically, hydraulically or electrically adjustable. In an embodiment, the biasing mechanism comprises a solenoid.

In an embodiment, the piston comprises the Tesla valve. In an embodiment, the Tesla valve is one of a plurality of Tesla valves, the piston comprising the plurality of Tesla valves. In an embodiment, each of the plurality of Tesla valves is aligned longitudinally within the piston.

In an embodiment, the inlet is a first inlet and the outlet is a first outlet, the fluid pump further comprising:
a second inlet;
a second outlet;
a first passage extending between the first inlet and the first outlet; and
a second passage extending between the second inlet and the second outlet,
wherein the cylinder extends between the first and second passages.

In an embodiment, the Tesla valve is a first Tesla valve in fluid communication with the first inlet, the fluid pump comprising a second Tesla valve in fluid communication with the second inlet. In an embodiment, the first Tesla valve is one of a first plurality of Tesla valves in fluid communication with the first inlet and the second Tesla valve is one of a second plurality of Tesla valves in fluid communication with the second inlet In an embodiment, an outer surface of the piston comprises a low friction coating. In an embodiment, an inner surface of the cylinder comprises a low friction coating. In an embodiment, the low friction coating comprises or consists of polytetrafluoroethene.

In a second aspect there is provided a fuel delivery system for an aircraft powerplant, the fuel delivery system comprising a fluid pump, the fluid pump comprising:
a chamber comprising an inlet and an outlet, the outlet comprising a non-return valve, the chamber having a cavity comprising a cylinder;
a piston, slidably disposed within the cylinder; and
a Tesla valve in fluid communication with the inlet,
wherein the fluid pump is configured to pump fluid from the inlet to the outlet by reciprocation of the piston within the cylinder.

In an embodiment, the aircraft powerplant comprises a gas turbine engine. In an embodiment, the aircraft powerplant comprises a fuel cell.

Other features of the first aspect may apply equally to the fuel delivery system of the second aspect.

In a third aspect there is provided a method of pumping a cryogenic fluid using a fluid pump comprising:
a chamber comprising an inlet and an outlet, the outlet comprising a non-return valve, the chamber having a cavity comprising a cylinder;
a piston, slidably disposed within the cylinder; and
a Tesla valve in fluid communication with the inlet,
the method comprising pumping the cryogenic fluid from the inlet to the outlet by reciprocation of the piston within the cylinder.

Other features of the first aspect may apply equally to the method of the third aspect.

In an embodiment, the cryogenic fluid is a fuel for an aircraft powerplant. In an embodiment, the fuel is hydrogen.

### DESCRIPTION OF THE DRAWINGS

Embodiments will now be described by way of example only with reference to the accompanying drawings, which are purely schematic and not to scale, and in which:

FIG. 1 is a schematic diagram of an example hydrogen-fuelled airliner comprising hydrogen-fuelled turbofan engines;

FIG. 2 is a schematic diagram illustrating flow of hydrogen fuel from a storage tank to a turbofan engine;

FIG. 3 is a schematic block diagram of an example fuel delivery system for a hydrogen-fuelled turbofan engine;

FIG. 4a is a schematic sectional diagram of an example fuel pump with a piston in a first position;

FIG. 4b is a schematic sectional diagram of the example fuel pump of FIG. 4a with the piston in a second position;

FIGS. 5a and 5b are schematic diagrams of an example piston for a fuel pump comprising a plurality of Tesla valves;

FIG. 6 is a schematic sectional diagram of an example Tesla valve; and

FIG. 7 is a schematic sectional diagram of an alternative example fuel pump.

### DETAILED DESCRIPTION

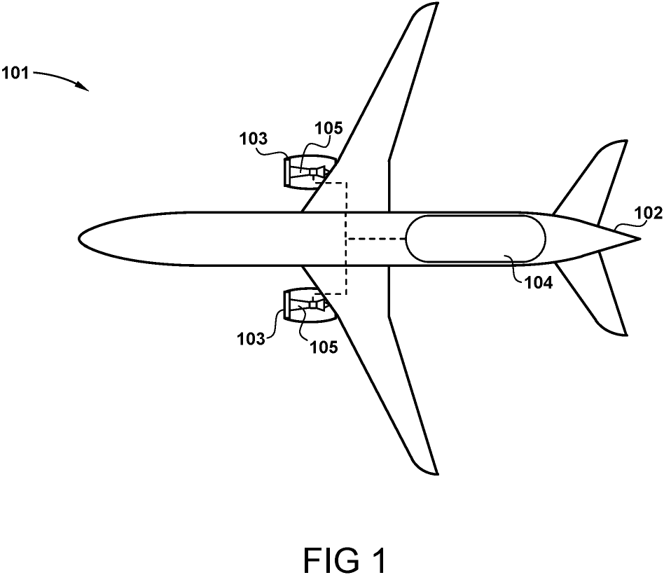

A hydrogen-fuelled airliner is illustrated in FIG. 1. In this example, the airliner 101 is of substantially conventional tube-and-wing twinjet configuration with a central fuselage 102 and substantially identical underwing-mounted turbofan engines 103. The turbofan engines 103 may for example be geared turbofan engines.

A hydrogen storage tank 104 located in the fuselage 104 for a hydrogen fuel supply is connected with core gas turbines 105 in the turbofan engines 103 via a fuel delivery system. In the illustrated example, the hydrogen storage tank 104 is a cryogenic hydrogen storage tank that stores the hydrogen fuel in a liquid state, in a specific example at 20 K. The hydrogen fuel may be pressurised to between around from 1 to 3 bar, for example around 2 bar.

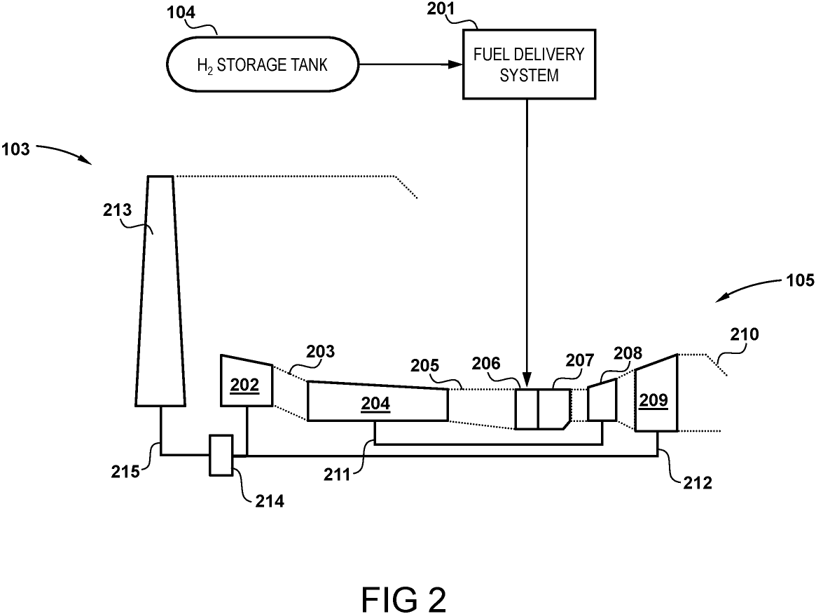

A block diagram identifying the flow of hydrogen fuel is shown in FIG. 2. Hydrogen fuel is obtained from a hydrogen storage tank 104 by a fuel delivery system 201 and is supplied to a core of a gas turbine 105. Only one of the gas turbines is shown for clarity. In this illustrated embodiment, the gas turbine 105 is a simple cycle gas turbine engine. In other embodiments, complex cycles may be implemented via fuel-cooling of the gas path.

Referring again to FIG. 2, the gas turbine 105 comprises, in axial flow series, a low-pressure compressor 202, an interstage duct 203, a high-pressure compressor 204, a diffuser 205, a fuel injection system 206, a combustor 207, a high-pressure turbine 208, a low-pressure turbine 209, and a core nozzle 210. The fuel injection system 206 may be a lean direct fuel injection system. The high-pressure compressor 204 is driven by the high-pressure turbine 208 via a first shaft 211 and the low-pressure compressor 202 is driven by the low-pressure turbine 209 via a second shaft 212. In alternative examples, the gas turbine 105 may comprise more than two shafts.

In a geared turbofan engine the low-pressure turbine 209 also drives a fan 213 via a reduction gearbox 214. The reduction gearbox 214 receives an input drive from the second shaft 212 and provides an output drive to the fan 213 via a fan shaft 215. The reduction gearbox 214 may be an epicyclic gearbox, which may be of planetary, star or compound configuration. In further alternatives, the reduction gearbox 214 may be a layshaft-type reduction gearbox or another type of reduction gearbox. It will also be appreciated that the principles disclosed herein may be applied to a direct-drive type turbofan engine, i.e. in which there is no reduction gearbox between the low-pressure turbine 209 and the fan 213.

### Fuel Delivery System

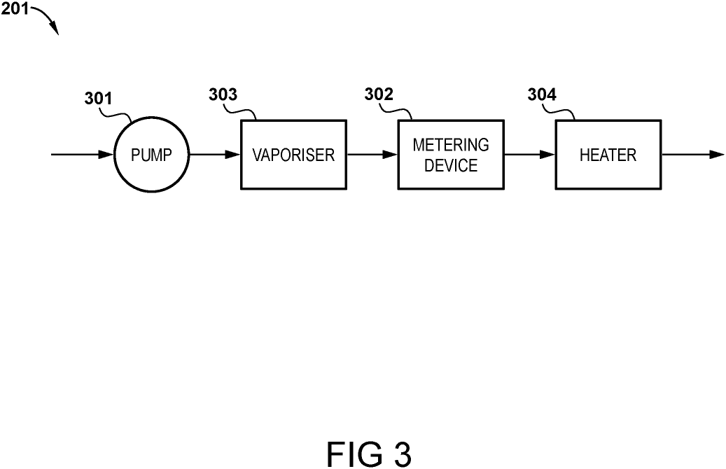

In operation, the fuel delivery system 201 is configured to obtain hydrogen fuel from the hydrogen storage tank 104 and provide the fuel to the fuel injection system 206. FIG. 3 is a block diagram illustrating the fuel delivery system 201 in greater detail. The fuel delivery system 201 comprises a pump 301, a vaporiser 303, a metering device 302 and a heater 304 for heating the hydrogen fuel to an injection temperature for the fuel injection system 206. A vent system (not shown) may be included in the fuel delivery system 201 close to the fuel injection system 206 to vent hydrogen fuel should a rapid shut-off be required, for example in response to a shaft-break event. It is envisaged that the vent system may vent the excess hydrogen fuel into the bypass duct of the turbofan engine 103, or alternatively vent it outside of the nacelle of the engine 103. An igniter may be provided to flare off the excess hydrogen in a controlled manner.

In alternative arrangements, the fuel delivery system may deliver fuel to an aircraft powerplant other than a gas turbine engine, for example a fuel cell. In a general aspect therefore, the fuel delivery system may deliver fuel to an aircraft powerplant, which may comprise a fuel cell and/or a gas turbine engine. The gas turbine engine may for example drive a turbofan engine or a turboprop engine or may be used as a generator for generating electricity for propulsion or otherwise.

### Fluid Pump

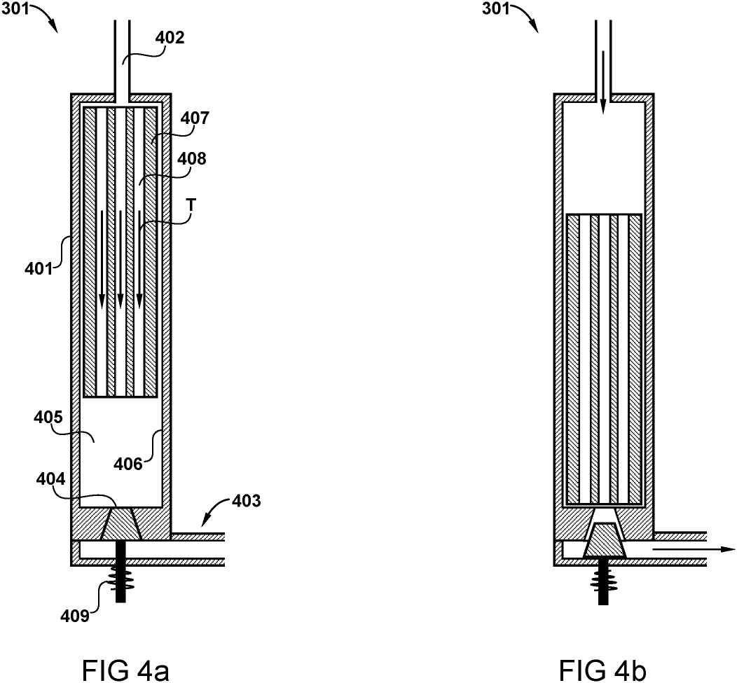

FIGS. 4a and 4b illustrate schematically an embodiment of the pump 301 for the fuel delivery system 201. The pump 301 comprises a chamber 401 defining a cylinder 406 in which a piston 407 is slidably disposed. The chamber 401 comprises an inlet 402 at one end of the chamber 401 and an outlet 403 at an opposing end of the chamber 401. The outlet 403 comprises a non-return valve 404. In the illustrated example, the piston 407 comprises a plurality of Tesla valves 408. Each Tesla valve 408 is in fluid communication with the inlet 402. The pump 301 is configured to pump fluid, for example a cryogenic fluid such as hydrogen or helium or a supercritical fluid, from the inlet 402 to the outlet 403 by reciprocation of the piston 407 within the cylinder 406. In this example, the piston 407 comprises a plurality of Tesla valves 408, although in general terms one or more Tesla valves may be used. In the orientation shown the inlet 402 is at the top of the pump 301 and the outlet 403 is at the bottom, although the pump 301 may operate in other orientations. In the configuration shown in FIG. 4a the piston 407 is located at the top of the cylinder 406, the lower part of the cavity 405 contains fluid and the non-return valve 404 is closed, while in the configuration shown in FIG. 4b the piston 407 is located at the bottom of the cylinder 406, the fluid is ejected through the outlet 403 and fluid enters the cylinder 406 through the inlet 402.

The outlet 403 comprises a biasing mechanism 409 to maintain the valve 404 closed below a preset pressure. The biasing mechanism 409 may be adjustable to allow the present pressure to be set. This may for example be achieved by selecting a spring with a spring constant defining a desired force to maintain the valve 404 closed. In other arrangements the biasing mechanism may be pneumatically, hydraulically or electrically controllable. An adjustable biasing mechanism may for example comprise a solenoid, which in some examples may be superconducting when pumping cryogenic fluids.

In operation, the piston 407 is driven downwards towards the bottom of the cylinder as depicted in FIG. 4b. As the piston 407 is driven downwards, the fluid in the lower part of the cavity 405 increases in pressure. When the fluid reaches the desired pressure level corresponding the adjustable biasing mechanism setting, the non-return valve 404 begins to allow fluid to flow through the outlet 403 as the piston 407 continues to move downwards, and the high pressure fluid exits the pump 301 through the outlet 403. The Tesla valves 408 (described in further detail below in relation to FIG. 6) limit fluid from flowing back through the piston 407 as the piston 407 is driven downwards by flow through the Tesla valves having a preferred flow direction indicated by the arrows T. The flow rate of fluid through the pump 301 is determined by the driving speed of the piston 407, i.e. the faster the piston reciprocates in the cylinder the greater the overall flow rate will be. A sufficient amount of fluid is required to enter the Tesla valves 408 in the upwards direction to create adequate downwards pressure by redirecting the fluid to mitigate backflow. Only a small portion of the fluid may therefore return to the top of the cavity 405 as the piston 407 is driven downwards. Once the piston 407 reaches the bottom of the cylinder it is driven in the reverse direction and begins to move to the top of the cylinder as in FIG. 4a. The Tesla valves 408 then allow fluid to move more freely into the lower part of the cavity in the preferred flow direction T.

The piston 407 may be driven in various ways. Options may for example include linear actuators (electrical linear motors) or mechanical driving arrangements driving the piston either electrically via rotating parts or via linear actuators located outside or inside the pump housing. A nutating disk engine may for example be driven electrically or mechanically, or may be driven by expanding hot or cold gases or by combustion of hydrogen. Direct mechanical coupling with a prime mover may be used, with optional mechanical gearing to control the rotating speeds.

The piston may be formed of materials such as steel, e.g. stainless steel, a nickel-base alloy, e.g. an Inconel (RTM), or composite materials. The Tesla valves 408 may be formed of similar materials to the surrounding piston. The piston 407 may comprise an outer surface coating or layer of a low friction material such as polytetrafluoroethene (PTFE) or another dry lubricant layer such as graphite. The inner side of the chamber 406 may also be coated with a similar low coefficient material. In an example where the piston 407 is driven electrically from outside of the chamber 401, the piston 407 may comprise a PTFE outer layer, an inner stainless steel shell and Tesla valves formed of an Inconel alloy.

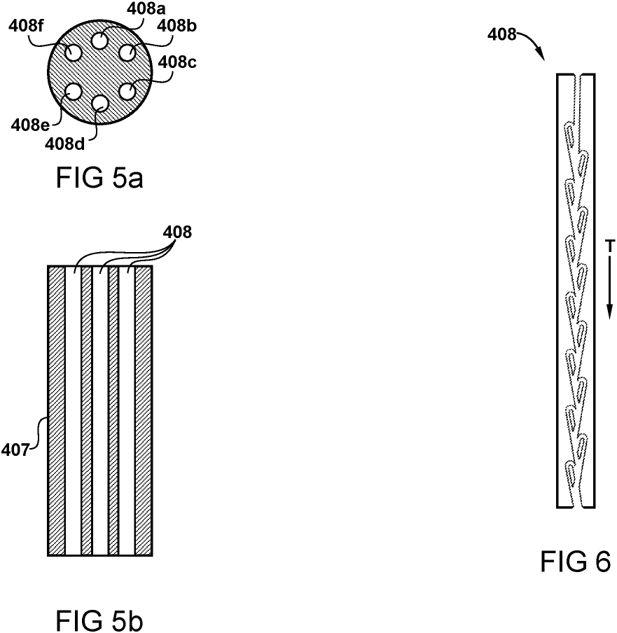

FIGS. 5a and 5b illustrate an end view and a sectional view of the example piston 407 comprising a plurality of Tesla valves 408. In this example, six Tesla valves 408a-f are provided in the piston 407 in a parallel rotationally symmetric arrangement with the Tesla valves 408a-f in an annular arrangement. Using a plurality of Tesla valves in a parallel arrangement allows for a greater fluid flow rate through the pump 301. The Tesla valves may be arranged in different configurations and greater or fewer than six may be used.

FIG. 6 illustrates a sectional diagram of an example Tesla valve 408, showing the internal arrangement of the valve that allows for a preferred fluid flow direction T. In this orientation the fluid moves with little resistance in the flow direction T but will have much higher resistance in the reverse direction due to flow in the reverse direction causing turbulent flow within the valve 408. The orientation of the valve 408, i.e. with the preferred flow direction T downwards, corresponds to that shown in FIGS. 4a and 4b.

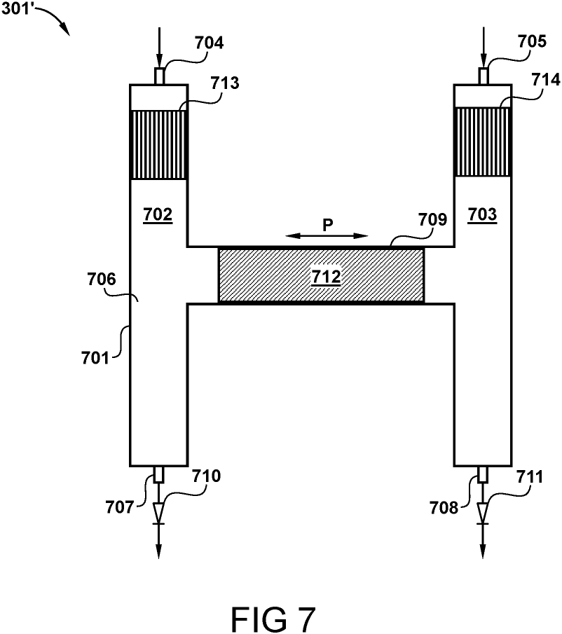

FIG. 7 illustrates schematically an alternative embodiment of the pump 301' comprising Tesla valves, in which the fluid pump 301' has an ‘H’ configuration rather than the linear configuration of the example in FIGS. 4a and 4b. As with the fluid pump of FIGS. 4a and 4b, the pump 301' comprises a chamber 701 having a cavity 706 comprising a cylinder 709, a piston 712 being slidably disposed within the cylinder, and a Tesla valve 713, 714. The pump 301' comprises a first inlet 704, a first outlet 707, a second inlet 705 and a second outlet 708. The first outlet 707 comprises a first non-return valve 710 and the second outlet 708 comprises a second non-return valve 711. A first fluid passage 702 extends between the first inlet 704 and the first outlet 707. A second fluid passage 703 extends between the second inlet 705 and the second outlet 708.

A first Tesla valve 713 is in fluid communication with the first inlet 704 and a second Tesla valve 714 is in fluid communication with the second inlet 705. The cylinder 709 within which the piston 712 is provided extends between the first fluid passage 702 and the second fluid passage 703. Because in this example the piston reciprocates between the first and second passages, fluid flow is alternately pumped through the first and second outlets 707, 708, allowing for a more continuous flow of fluid through the pump 301' compared to the pump 301 of FIGS. 4a and 4b. As the piston is driven from left to right as shown by arrow P, fluid enters the first fluid passage 702 through the first Tesla valve 713 via the first inlet 704 and is compressed in the second fluid passage 703. The Tesla valve 714 in fluid communication with the second inlet 705 prevents backflow, provided a minimum fluid flow rate passing through the pump 301' is achieved. When the pressure exceeds a pre-set pressure, the second non-return valve 711 opens and high-pressure fluid exits the passage 703 through the second outlet 708. When the piston 712 then travels from right to left, the process repeats for the first passage 702, causing fluid to exit via the first outlet 707 and be drawn into the second passage 703 via the second inlet 705.

In the example illustrated in FIG. 7, Tesla valves 713, 714 are located in the respective first and second passages 702, 703 at or proximate the respective first and second inlets 704, 705. These Tesla valves, allowing fluid to flow more easily in one direction than an opposing direction, effectively acting as non-return valves. In some alternatives, for example involving slow fluid flow rates, further non-return valves may be provided at the first and second inlets 704, 705, which may be in the form of the non-return valve in the example shown in FIGS. 4a and 4b. In other alternatives, for example involving faster fluid flow rates, Tesla valves may be used as non-return valves for the inlets 704, 705 and the outlets 710, 711, i.e. the non-return valve at each outlet may also comprise or be in the form of a Tesla valve. To allow for a controlled or adjustable pressure at which the outlets allow fluid to pass through, the outlets may also comprise a non-return valve of the type described above in relation to FIGS. 4a and 4b.

As with the example illustrated in FIGS. 4a and 4b, the piston 712 may be similarly coated with a low coefficient material such as PTFE. The inner surface of the cylinder 709 may also similarly coated for pumping cryogenic fluids.

As with the example in FIGS. 4a and 4b, each passage 702, 703 may comprise one or more Tesla valves, for example in an arrangement as shown in FIGS. 5a and 5b. The Tesla valves may be provided at the first and second inlets 704, 705 as in the illustration of FIG. 7 or may be provided at other points within the first and second passages 702, 703, in each case with a preferred flow direction towards the first and second outlets 710, 711.

In both of the illustrated examples, a sufficient flow rate of fluid through the pump 301, 301' mitigates fluid leakage around the piston sides and through the Tesla valves.

A fluid pump of the type disclosed herein may be used as a fuel pump for a hydrogen-powered turbofan engine in an aircraft. The fluid pump may, however, also be used in other applications for pumping fluids, particularly cryogenic fluids.

Various examples have been described, each of which comprise various combinations of features. It will be appreciated by those skilled in the art that, except where clearly mutually exclusive, any of the features may be employed separately or in combination with any other features and thus the disclosed subject-matter extends to and includes all such combinations and sub-combinations of the or more features described herein.

1. A fluid pump comprising:
a chamber comprising an inlet and an outlet, the outlet comprising a non-return valve, the chamber having a cavity comprising a cylinder;
a piston slidably disposed within the cylinder; and
a Tesla valve in fluid communication with the inlet,
wherein the fluid pump is configured to pump fluid from the inlet to the outlet by reciprocation of the piston within the cylinder.

2. The fluid pump of claim 1, wherein the non-return valve comprises a biasing mechanism to bias the non-return valve towards being closed.

3. The fluid pump of claim 2, wherein the biasing mechanism comprises a spring.

4. The fluid pump of claim 2, wherein the biasing mechanism is adjustable.

5. The fluid pump of claim 4, wherein the biasing mechanism is pneumatically, hydraulically, or electrically adjustable.

6. The fluid pump of claim 5, wherein the biasing mechanism comprises a solenoid.

7. The fluid pump of claim 1, wherein the piston comprises the Tesla valve.

8. The fluid pump of claim 7, wherein the Tesla valve is one of a plurality of Tesla valves, the piston comprising the plurality of Tesla valves.

9. The fluid pump of claim 8, wherein each of the plurality of Tesla valves is aligned longitudinally within the piston.

10. The fluid pump of claim 1, wherein the inlet is a first inlet and the outlet is a first outlet, the fluid pump further comprising:
a second inlet;
a second outlet;
a first passage extending between the first inlet and the first outlet; and
a second passage extending between the second inlet and the second outlet,
wherein the cylinder extends between the first and second passages.

11. The fluid pump of claim 10, wherein the Tesla valve is a first Tesla valve in fluid communication with the first inlet, the fluid pump comprising a second Tesla valve in fluid communication with the second inlet.

12. The fluid pump of claim 11, wherein the first Tesla valve is one of a first plurality of Tesla valves in fluid communication with the first inlet and the second Tesla valve is one of a second plurality of Tesla valves in fluid communication with the second inlet.

13. The fluid pump of claim 1, wherein an outer surface of the piston comprises a low friction coating.

14. The fluid pump of claim 13, wherein an inner surface of the cylinder comprises a low friction coating.

15. The fluid pump of claim 13, wherein the low friction coating comprises or consists of polytetrafluoroethene.

16. A fuel delivery system for an aircraft powerplant, the fuel delivery system comprising a fluid pump according to claim 1.

17. The fuel delivery system of claim 16, wherein the aircraft powerplant comprises a gas turbine engine and/or a fuel cell.

18. A method of pumping a cryogenic fluid using a fluid pump comprising:
a chamber comprising an inlet and an outlet, the outlet comprising a non-return valve, the chamber having a cavity comprising a cylinder;
a piston slidably disposed within the cylinder; and
a Tesla valve in fluid communication with the inlet,
the method comprising pumping the cryogenic fluid from the inlet to the outlet by reciprocation of the piston within the cylinder.

19. The method of claim 18, wherein the cryogenic fluid is a fuel for an aircraft powerplant.

20. The method of claim 19, wherein the fuel is hydrogen.
